(19) United States
(12) Patent Application Publication
(10) Pub. No.: US 2006/0183631 A1
(43) Pub. Date: Aug. 17, 2006

(54) Supported metallocene catalyst and method of preparing ethylene-based copolymer using the same

(76) Inventors: Sangwoo Lee, Daejeon-city (KR); Ki Soo Lee, Daejeon-city (KR); Yonggyu Han, Daejeon-city (KR); Yiyoung Choi, Daejeon-city (KR); Hoon Chae, Seoul (KR); Seungwhan Jung, Suwon-city (KR)

Correspondence Address: CANTOR COLBURN, LLP, 55 GRIFFIN ROAD SOUTH, BLOOMFIELD, CT, 06002, US

(21) Appl. No.: 11/354,509

(22) Filed: Feb. 15, 2006

(30) Foreign Application Priority Data
Feb. 15, 2005 (KR) 10-2005-0012450

(51) Int. Cl. B01J 31/00

(52) U.S. Cl. 502/117; 502/103; 502/152; 526/113; 526/118; 526/318.5; 526/348.6; 526/348.2; 526/348.3

(57) ABSTRACT

An ethylene-based copolymer prepared using a supported hybrid metallocene catalyst is provided. The ethylene-based copolymer is prepared using a supported hybrid metallocene catalyst in which two different metallocene catalysts are supported on a support and has a bimodal or multimodal molecular weight distribution. Accordingly, the ethylene-based copolymer has superior processability, sanitation, and internal pressure creep resistance at high temperature. A supported hybrid metallocene catalyst used to prepare the ethylene-based copolymer is also provided.

### CROSS-REFERENCE TO RELATED PATENT APPLICATION

This application claims the benefit of Korean Patent Application No. 10-2005-0012450, filed on Feb. 15, 2005, in the Korean Intellectual Property Office, the disclosure of which is incorporated herein in its entirety by reference.

### BACKGROUND OF THE INVENTION

1. Field of the Invention

The present invention relates to a supported hybrid metallocene catalyst and a method of preparing an ethylene-based copolymer using the same, and more particularly, to a supported hybrid metallocene catalyst in which a metallocene catalyst for preparation of a low molecular weight ethylene-based copolymer and a metallocene catalyst for preparation of a high molecular weight ethylene-based copolymer are supported on one support, a method of preparing an ethylene-based copolymer using the same, and a molded material for pipes, prepared using an ethylene-based copolymer prepared by the method.

2. Description of the Related Art

A water supply pipe and a pipe for hot water supplying which must coexist with a building are generally 50-year in a warranty period based on water of 20′. Thus, many studies for improvement of heat resistance and durability have been accomplished. Plastics used as materials for a water supply pipe and a pipe for heating are polybutene (PB), crosslinked polyethylene (XLPE), polypropylene block copolymer (PPC), polypropylene random copolymer (PPR), etc. These materials have advantages and disadvantages in performance and price. In particular, in the case of polyethylene (PE), the use of a connector could be minimized due to its excellent flexibility together with the fact that it had been already long ago verified to be non-toxic as a drinkable water pipe, and thus it was selected as an optimal plastic. However, due to poor heat resistance and durability, it is impossible to use the polyethylene resin alone. The heat resistance and durability have been increased through chemical crosslinking or electron beam irradiation crosslinking method using organic peroxide or silane.

The chemical crosslinking method is described in detail in Japanese Patent Publication Nos. Sho 45-035658, 48-001711, and 63-058090, Hei 2-253076 and 7-258496, U.S. Pat. Nos. 4,426,497, 4,446,286, and 6,284,178.

Japanese Patent Laid-Open Publication No. Hei 8-073670 discloses a crosslinked polyethylene composition including a copolymer of ethylene and 1-butene, having a specific melt index, and Japanese Patent Laid-Open Publication No. Hei 9-324081 discloses a crosslinked polyethylene pipe fabricated using polyethylene and a specific antioxidant. Japanese Patent Publication No. Sho 57-170913 discloses a crosslinked pipe fabricated using polyethylene with a specific density and molecular weight, and Japanese Patent Laid-Open Publication Nos. Hei 9-020867 and 7-157568 disclose a crosslinked pipe fabricated using a silane modified graft polyethylene with a narrow molecular weight distribution. Japanese Patent Publication No. Sho 60-001252 discloses a crosslinked pipe fabricated using an activated carbon, silica, and alumina, Japanese Patent Laid-Open Publication No. Hei 10-182757 discloses a pipe for supplying water or hot water, fabricated using a specific organic unsaturated silane and a specific radical generator, and Japanese Patent Laid-Open Publication No. Hei 6-248089 discloses a crosslinked pipe fabricated using a high density polyethylene.

However, in the prior arts, the crosslinking of polyethylene requires high costs due to complicated production process and poor pipe processability, and recycling of crosslinked products is difficult, and thus, production of an environmental friendly pipe is difficult. Further, since the chemical crosslinking method does not achieve uniform degree of crosslinking, the homogeneity of products is poor and productivity and cost effectiveness are low. The crosslinked pipe is not suitable for drinking water, flexibility in the installation is diminished, and heat bonding is difficult due to the unreacted residue monomers. To compensate for sanitation, a crosslinking method using electron beam was designed. However, this method is limited in producing pipes due to high crosslinking apparatus costs.

To address these problems, a method of preparing linear middle density polyethylene (LMDPE) which has superior thermal resistance and long-term hydrostatic stress-crack resistance and is environmentally friendly was developed. This method is characterized by using a high alpha-olefin comonomer, which makes it easy to produce a tie-molecule having proper size and molecular weight, to provide LMDPE which has similar physical properties to the crosslinked polyethylene. This disclosure can be found in Korean Patent Publication No. 2003-74003.

Since the non-crosslinked LMDPE is polymerized in a single solution reactor, it is difficult to control a molecular weight distribution, resulting in a narrow molecular weight distribution. As a result, load of extruder increases when molding a pipe, and appearance of a pipe surface is poor, which are due to a poor processability. To address these problems, an expensive fluorine-based processing aid is used, but it takes long time to stabilize, and loss of raw materials is significant, resulting in an increase in production costs. Moreover, due to a high polymerization process cost, a raw material cost is about two times higher than a raw material cost for chemical crosslinking.

Meanwhile, there was an attempt to control a molecular weight distribution using a multistage reactor in order to improve durability and heat resistance of polyethylene while maintaining good inherent properties thereof. However, additional apparatus costs and a large amount of raw material are required and the apparatus handling is difficult.

To control a molecular weight distribution without the multistage reactor, the use of metallocene catalyst has been attempted as described below.

Polyethylene, isotactic polypropylene, ethylene propylene diene copolymer (EPDM), etc. which have various physical properties have been developed since a Ziegler-Natta catalyst was developed as a catalyst for synthesis of polyolefin in the middle of 1950's. However, the Ziegler-Natta catalyst did not provide polymers of which molecular weight distribution and compositional distribution are narrow and uniform due to its non-uniform active site.

A metallocene catalyst which was developed after the early 1980's solved the problems of the Ziegler-Natta catalyst. The metallocene catalyst can synthesize polymers of which a molecular weight distribution and a compositional distribution are narrow and uniform. Furthermore, polymers having various physical properties, such as syndiotactic polypropylene, syndiotactic polystyrene, etc., which could not be synthesized with the Ziegler-Natta catalyst, can be prepared. Polymers prepared using the metallocene catalyst has a narrow molecular weight distribution and an uniform compositional distribution and have higher strength, transparency and durability than polymers polymerized using the Ziegler-Natta catalyst. However, processability and moldability are poor due to a narrow molecular weight distribution upon processing.

Under this circumstance, to overcome the narrow molecular weight distribution of polymers prepared using the metallocene catalyst, it was proposed to blend polymers polymerized in separate reactors. Although this method is advantageous in that a molecular weight and a molecular weight distribution can be controlled by a blending ratio, problems in miscibility of two polymers may occur. Alternatively, a method of controlling the molecular weight distribution by changing operation parameters in a series of reactors was proposed. However, this method required additional apparatuses and is complicated. In addition, a method of controlling a molecular weight distribution using a catalyst in a reactor is advantageous that the processing is simple and cost-effective, but requires advanced technology and skill on catalyst.

U.S. Pat. No. 5,032,562 describes a method of preparing a polymerization catalyst by supporting two different transition metal catalysts on one support. This catalyst is prepared by supporting a Ti-based Ziegler-Natta catalyst which produces a high molecular weight polymer and a Zr-based metallocene catalyst which produces a low molecular weight polymer on one support and results in a bimodal molecular weight distribution. The supporting procedure is complicated and morphology of polymers is poor due to a cocatalyst.

U.S. Pat. No. 5,525,678 discloses a catalyst system for polymerization of olefins in which a metallocene compound and a non-metallocene compound are simultaneously supported on a support to simultaneously polymerize a high molecular weight polymer and a low molecular weight polymer. However, the metallocene compound and non-metallocene compound must be separately supported and the support must be pretreated with various compounds for supporting.

U.S. Pat. No. 5,914,289 describes a method of controlling the molecular weight and the molecular weight distribution of polymers using metallocene catalysts which are respectively supported on supports. A large amount of solvent and long time are required to prepare the supported catalysts and the process of supporting metallocene catalysts on the respective support is troublesome.

Korean Patent Application No. 2003-12308 discloses a method of controlling the molecular weight distribution of polymers by polymerizing while changing a combination of catalysts in a reactor by supporting a dinuclear metallocene catalyst and a mononuclear metallocene catalyst on a support with an activating agent. However, this method is limited in simultaneous implementation of properties of the respective catalysts. In addition, a metallocene catalyst portion is departed from a supported catalyst to cause fouling in the reactor.

### SUMMARY OF THE INVENTION

The present invention provides a supported hybrid metallocene catalyst which can prepare an ethylene-based copolymer having superior processability and long-term hydrostatic stress-crack resistance.

The present invention also provides a method of preparing the supported hybrid metallocene catalyst.

The present invention also provides a method of preparing an ethylene-based copolymer using the supported hybrid metallocene catalyst.

The present invention also provides an ethylene-based copolymer prepared by the method of preparing an ethylene-based copolymer.

The present invention also provides a molded material for pipes, prepared using the ethylene-based copolymer.

According to an aspect of the present invention, there is provided a supported hybrid metallocene catalyst comprising a first metallocene catalyst represented by formula (1), a second metallocene catalyst represented by formula (2) or (3), a cocatalyst, and a support:
(C₅R¹)ₚ(C₅R¹)MQ₃₋ₚ (1)

in which M is a Group IV transition metal;

(C₅R¹) is a cyclopentadienyl or a cyclopentadienyl ligand substituted by a metalloid radical of a Group XIV metal substituted by a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkylaryl group, a C₇₋₄₀ arylalkyl group, a C₈₋₄₀ arylalkenyl group, a C₂₋₁₀ alkynyl group, or a hydrocarbyl; or a cyclopentadienyl or a substituted cyclopentadienyl ligand wherein two neighboring carbon atoms of C₅ are connected by a hydrocarbyl radical to form at least one C₄ to C₈ ring;

Q is a halogen atom, a C₁₋₂₀ alkyl group, a C₂₋₁₀ alkenyl group, a C₇₋₄₀ alkylaryl group, a C₇₋₄₀ arylalkyl group, a C₆₋₂₀ aryl group, a substituted or unsubstituted C₁₋₂₀ alkylidene, a substituted or unsubstituted amino group, a C₂₋₂₀ alkylalkoxy group, or a C₇₋₄₀ arylalkoxy group; and

p is 0 or 1;

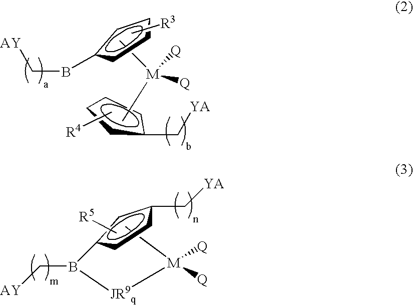

in which M is a Group IV transition metal;

each of (C₅R³), (C₅R⁴) and (C₅R⁵) is a cyclopentadienyl or a cyclopentadienyl ligand substituted by a metalloid radical of a Group XIV metal substituted by a C₁₋₄₀ alkyl group, a C₄₋₄₀ cycloalkyl group, a C₁₋₂₀ alkoxy group, a C₆₋₄₀ aryl group, a C₆₋₂₀ aryloxy group, a C₂₋₄₀ alkenyl group, a C₇₋₄₀ alkylaryl group, a C₇₋₄₀ arylalkyl group, a C₈₋₄₀ arylalkenyl group, a C₂₋₂₀ alkynyl group, or a hydrocarbyl; or a cyclopentadienyl or a substituted cyclopentadienyl ligand wherein two neighboring carbon atoms of C₅ are connected by a hydrocarbyl radical to form at least one C₄ to C₁₆ ring;

A is a hydrogen atom, a C₁₋₂₀ alkyl group, a C₂₋₂₀ alkenyl group, a C₆₋₂₀ aryl group, a C₇₋₄₀ alkylaryl group, a C₇₋₄₀ arylalkyl group, a C₁₋₂₀ alkylsilyl group, a C₆₋₂₀ arylsilyl group, methoxymethyl, t-butoxymethyl, tetrahydropyranyl, tetrahydrofuranyl, 1-ethoxyethyl, 1-methyl-1-methoxyethyl, or t-butyl;

Y is an oxygen or nitrogen atom;

Q is a halogen atom, a C₁₋₂₀ alkyl group, a C₂₋₁₀ alkenyl group, a C₇₋₄₀ alkylaryl group, a C₇₋₄₀ arylalkyl group, a C₆₋₂₀ aryl group, a substituted or unsubstituted C₁₋₂₀ alkylidene, a substituted or unsubstituted amino group, a C₂₋₂₀ alkylalkoxy group, or a C₇₋₄₀ arylalkoxy group;

B is a bridge that binds two cyclopentadienyl ligands or binds a cyclopentadienyl ligand and JR⁹_{q} by a covalent bond, the bridge comprising a C₁₋₄ alkylene group, C₁₋₄ dialkylsilicon or dialkylgermanium, or C₁₋₄ alkyl phosphine or amine;

R⁹ is a hydrogen atom, a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkylaryl group, a C₇₋₄₀ arylalkyl group, a C₈₋₄₀ arylalkenyl group, or a C₂₋₁₀ alkynyl group;

J is a Group XV element or a Group XVI element;

q is an integer of 0-3; and

each of a, b, m, and n is an identical or different integer of 0-20.

According to another aspect of the present invention, there is provided a method of preparing a supported hybrid metallocene catalyst, the method including: reacting a supported metallocene catalyst in which one of a first metallocene catalyst represented by formula (1) and a second metallocene catalyst represented by formula (2) or (3) is supported on a support with a cocatalyst to prepare an activated supported metallocene catalyst; and further supporting the other metallocene catalyst of the metallocene catalyst represented by formula (1) and the metallocene catalyst represented by formula (2) or (3) on the activated supported metallocene catalyst.

According to another aspect of the present invention, there is provided a method of preparing an ethylene-based copolymer, the method including: supplying a supported hybrid metallocene catalyst including a first metallocene catalyst represented by formula (1), a second metallocene catalyst represented by formula (2) or (3), a cocatalyst, and a support; an ethylene monomer; and a high α-olefin comonomer having at least 4 carbon atoms to a polymerization reactor to polymerize at 25-500° C. and 1-100 kg_{f}/cm² for 1-24 hours.

According to another aspect of the present invention, there is provided an ethylene-based copolymer prepared by the above method, which has a bimodal or multimodal molecular weight distribution, an ethylene content of 50-99 wt %, and a content of a high α-olefin having at least 4 carbon atoms of 1-50 wt %.

According to another aspect of the present invention, there is provided a molded material for pipes, prepared using the ethylene-based copolymer.

The above aspect(s) and advantages of the present invention will become more apparent by describing in detail an exemplary embodiment(s) thereof.

### DETAILED DESCRIPTION OF THE INVENTION

In the present invention, by using a supported hybrid metallocene catalyst in which two different metallocene catalysts are supported on a single support, ethylene-based copolymers prepared by copolymerizing ethylene and high α-olefin having at least 4 carbon atoms can have a bimodal or multimodal molecular weight distribution.

A supported hybrid metallocene catalyst according to an embodiment of the present invention is prepared by supporting a first metallocene catalyst represented by formula (1) and a second metallocene catalyst represented by formula (2) or (3) with a cocatalyst on a support:
(C₅R¹)ₚ(C₅R¹)MQ₃₋ₚ (1)

in which M is a Group IV transition metal;

(C₅R¹) is a cyclopentadienyl or a cyclopentadienyl ligand substituted by a metalloid radical of a Group XIV metal substituted by a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkylaryl group, a C₇₋₄₀ arylalkyl group, a C₈₋₄₀ arylalkenyl group, a C₂₋₁₀ alkynyl group, or a hydrocarbyl; or a cyclopentadienyl or a substituted cyclopentadienyl ligand wherein two neighboring carbon atoms of C₅ are connected by a hydrocarbyl radical to form at least one C₄ to C₈ ring;

Q is a halogen atom, a C₁₋₂₀ alkyl group, a C₂₋₁₀ alkenyl group, a C₇₋₄₀ alkylaryl group, a C₇₋₄₀ arylalkyl group, a C₆₋₂₀ aryl group, a substituted or unsubstituted C₁₋₂₀ alkylidene, a substituted or unsubstituted amino group, a C₂₋₂₀ alkylalkoxy group, or a C₇₋₄₀ arylalkoxy group; and

p is 0 or 1;

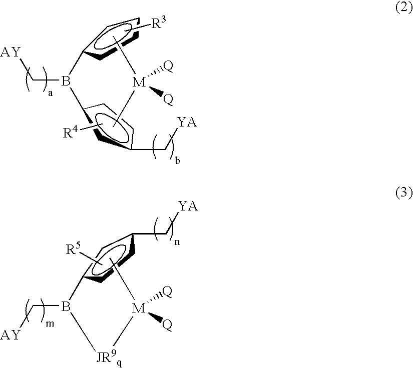

in which M is a Group IV transition metal;

each of (C₅R³), (C₅R⁴) and (C₅R⁵) is a cyclopentadienyl or a cyclopentadienyl ligand substituted by a metalloid radical of a Group XIV metal substituted by a C₁₋₄₀ alkyl group, a C₄₋₄₀ cycloalkyl group, a C₁₋₂₀ alkoxy group, a C₆₋₄₀ aryl group, a C₆₋₂₀ aryloxy group, a C₂₋₄₀ alkenyl group, a C₇₋₄₀ alkylaryl group, a C₇₋₄₀ arylalkyl group, a C₈₋₄₀ arylalkenyl group, a C₂₋₂₀ alkynyl group, or a hydrocarbyl; or a cyclopentadienyl or a substituted cyclopentadienyl ligand wherein two neighboring carbon atoms of C₅ are connected by a hydrocarbyl radical to form at least one C₄ to C₁₆ ring;

A is a hydrogen atom, a C₁₋₂₀ alkyl group, a C₂₋₂₀ alkenyl group, a C₆₋₂₀ aryl group, a C₇₋₄₀ alkylaryl group, a C₇₋₄₀ arylalkyl group, a C₁₋₂₀ alkylsilyl group, a C₆₋₂₀ arylsilyl group, methoxymethyl, t-butoxymethyl, tetrahydropyranyl, tetrahydrofuranyl, 1-ethoxyethyl, 1-methyl-1-methoxyethyl, or t-butyl;

Y is an oxygen or nitrogen atom;

Q is a halogen atom, a C₁₋₂₀ alkyl group, a C₂₋₁₀ alkenyl group, a C₇₋₄₀ alkylaryl group, a C₇₋₄₀ arylalkyl group, a C₆₋₂₀ aryl group, a substituted or unsubstituted C₁₋₂₀ alkylidene, a substituted or unsubstituted amino group, a C₂₋₂₀ alkylalkoxy group, or a C₇₋₄₀ arylalkoxy group;

B is a bridge that binds two cyclopentadienyl ligands or binds a cyclopentadienyl ligand and JR⁹_{q} by a covalent bond, the bridge comprising a C₁₋₄ alkylene radical, C₁₋₄ dialkylsilicon or dialkylgermanium, or C₁₋₄ alkyl phosphine or amine;

R⁹ is a hydrogen atom, a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkylaryl group, a C₇₋₄₀ arylalkyl group, a C₈₋₄₀ arylalkenyl group, or a C₂₋₁₀ alkynyl group;

J is a Group XV element or a Group XVI element;

q is an integer of 0-3; and

each of a, b, m, and n is an identical or different integer of 0-20.

The first metallocene catalyst primarily contributes to prepare a low molecular weight copolymer and the second metallocene catalyst primarily contributes to prepare a high molecular weight copolymer. In particular, the second metallocene catalyst for preparing high molecular weight components reacts to the high α-olefin having at least 4 carbon atoms to prepare high performance ethylene-based copolymers in which the high α-olefin comonomers are concentrated in a high molecular chain side.

In the metallocene catalysts represented by formulae (1) to (3), it is advantageous in olefin polymerization that the content of M in each of the metallocene catalysts is 0.1-20 wt %. The content of M is preferably 0.1-10 wt %, and more preferably 1-3 wt %. When the content of M is less than 0.1 wt %, catalytic activity may become weak and when the content of M is greater than 20 wt %, it is economically unfavourable.

The cocatalyst which is supported with the metallocene catalyst on a support to activate the metallocene compounds is an organometallic compound containing a Group XIII metal and may be a cocatalyst used when polymerizing olefin under a general metallocene catalyst. Compounds represented by formulae (4) to (6) may be used alone or in combination as a cocatalyst.
—[Al(R⁶)—O]_{c}— (4)

in which R⁶ is an identical or different halogen radical, C₁₋₂₀ hydrocarbyl radical, or C₁₋₂₀ hydrocarbyl radical substituted by halogen; and c is an integer of 2 or more.

The compound represented by formula (4) may be a linear, cyclic, or net-shaped compound.
N(R⁶)₃ (5)

In which N is aluminium or boron, R⁶ is as defined in formula (4), and three R⁶s are identical or different.
[L-H]⁺[NE₄]⁻ or [L]⁺[NE₄]⁻ (6)

in which L is a neutral or cationic Lewis acid, H is a hydrogen atom, N is a Group XIII element, E is a C₆₋₄₀ aryl radical substituted by at least one among a halogen radical, a C₁₋₂₀ hydrocarbyl radical, an alkoxy radical, a phenoxy radical, and a C₁₋₂₀ hydrocarbyl radical containing nitrogen, phosphorus, sulfur, or oxygen atom, and four Es are identical or different.

Examples of the compound represented by formula (4) include methylaluminoxane (MAO), ethylaluminoxane, isobutylaluminoxane, butylaluminoxane, etc.

Examples of the alkyl metal compound represented by formula (5) include trimethylaluminium, triethylaluminium, triisobutylaluminium, tripropylaluminium, tributylaluminium, dimethylchloroaluminium, dimethylisobutylaluminium, dimethylethylaluminium, diethylchloroaluminium, triisopropylaluminium, tri-s-butylaluminium, tricyclopentylaluminium, tripentylaluminium, triisopentylaluminium, trihexylaluminium, ethyldimethylaluminium, methyldiethylaluminium, triphenylaluminium, tri-p-tolylaluminium, dimethylaluminiummethoxide, dimethylaluminiumethoxide, trimethylboron, triethylboron, triisobutylboron, tripropylboron, tributylboron, etc.

Examples of the compound represented by formula (6) include triethylammoniumtetraphenylboron, tributylammoniumtetraphenylboron, trimethylammoniumtetraphenylboron, tripropylammoniumtetraphenylboron, trimethylammoniumtetra(p-tolyl)boron, tripropylammoniumtetra(p-tolyl)boron, triethylammoniumtetra(o,p-dimethylphenyl)boron, trimethylammoniumtetra(o,p-dimethylphenyl)boron, tributylammoniumtetra(p-trifluoromethylphenyl)boron, trimethylammoniumtetra(p-trifluoromethylphenyl)boron, tributylammoniumtetrapentafluorophenylboron, N,N-diethylaniliniumtetraphenylboron, N,N-dimethylaniliniumtetraphenylboron, N,N-diethylaniliniumtetrapentafluorophenylboron, diethylammoniumtetrapentafluorophenylboron, triphenylphosphoniumtetraphenylboron, trimethylphosphoniumtetraphenylboron, triethylammoniumtetraphenylaluminium, tributylammoniumtetraphenylaluminium, trimethylammoniumtetraphenylaluminium, tripropylammoniumtetraphenylaluminium, trimethylammoniumtetra(p-tolyl)aluminium, tripropylammoniumtetra(p-tolyl)aluminium, triethylammoniumtetra(o,p-dimethylphenyl)aluminium, tributylammoniumtetra(p-trifluoromethylphenyl)aluminium, trimethylammoniumtetra(p-trifluoromethylphenyl)aluminium, tributylammoniumtetrapentafluorophenylaluminium, N,N-diethylaniliniumtetraphenylaluminium, N,N-diethylaniliniumtetraphenylaluminium, N,N-diethylaniliniumtetrapentafluorophenylaluminium, diethylammoniumtetrapentafluorophenylaluminium, triphenylphosphoniumtetraphenylaluminium, trimethylphosphoniumtetraphenylaluminium, triethylammoniumtetraphenylboron, tributylammoniumtetraphenylboron, trimethylammoniumtetraphenylboron, tripropylammoniumtetraphenylboron, trimethylammoniumtetra(p-tolyl)boron, tripropylammoniumtetra(p-tolyl)boron, triethylammoniumtetra(o,p-dimethylphenyl)boron, trimethylammoniumtetra(o,p-dimethylphenyl)boron, tributylammoniumtetra(p-trifluoromethylphenyl)boron, trimethylammoniumtetra(p-trifluoromethylphenyl)boron, tributylammoniumtetrapentafluorophenylboron, N,N-diethylaniliniumtetraphenylboron, N,N-diethylaniliniumtetraphenylboron, N,N-diethylaniliniumtetrapentafluorophenylboron, diethylammoniumtetrapentafluorophenylboron, triphenylphosphoniumtetraphenylboron, triphenylcarboniumtetraphenylboron, triphenylcarboniumtetraphenylaluminium, triphenylcarboniumtetra(p-trifluoromethylphenyl)boron, triphenylcarboniumtetrapentafluorophenylboron, etc.

Examples of a support useful for the supported hybrid catalyst include silica, silica-alumina, silica-magnesia dried at high temperatures, and the like. These supports may typically contain oxides such as Na₂O, carbonates such as K₂CO₃, sulfates such as BaSO₄, nitrates such as Mg(NO₃)₂. Although a smaller amount of hydroxy groups (—OH) on the surface of the support is preferable, removal of all hydroxy groups is practically impossible. The amount of the hydroxy groups (—OH) is preferably 0.1-10 mmol/g, and more preferably 0.1-1 mmol/g, still more preferably 0.1-0.5 mmol/g. The amount of the surface hydroxy groups (—OH) can be controlled by various preparation processes or drying conditions of a support (for example, temperature, time, and drying method). To reduce side reactions by residue hydroxy groups (—OH) which remain after drying, a catalyst prepared by chemically removing hydroxy groups (—OH) while maintaining highly reactive siloxane groups involved in supporting can also be used.

In the supported hybrid metallocene catalyst, a mole ratio of the Group XIII metal/M of the metallocene catalyst is preferably 1-10,000, more preferably 1-1,000, still more preferably 10-100. When the mole ratio is less than 1, it is difficult to obtain catalytic activity. When the mole ratio is greater than 10,000, it is economically unfavourable. Further, to obtain various molecular weight distribution of final polyolefin, a mole ratio of the first metallocene catalyst/the second metallocene catalyst of the supported hybrid metallocene catalyst may be 0.01-100. When the mole ratio of the first metallocene catalyst/the second metallocene catalyst is less than 0.01, it is difficult to obtain catalytic activity. When the mole ratio of the first metallocene catalyst/the second metallocene catalyst is greater than 100, it is economically unfavourable.

The supported hybrid metallocene catalyst is prepared by reacting one of the first metallocene catalyst and the second metallocene catalyst with the cocatalyst to prepare an activated supported metallocene catalyst, and then supporting the other metallocene catalyst on the activated supported metallocene catalyst.

An ethylene-based copolymer is prepared by reacting the supported hybrid metallocene catalyst, ethylene monomers, and a high α-olefin comonomer having at least 4 carbon atoms at 25-500° C. under a pressure of 1-100 kg_{f}/cm² for 1-24 hours. The polymerization temperature is preferably 25-200° C., more preferably 50-150° C. The polymerization pressure is preferably 1-50 kg_{f}/cm², more preferably 5-30 kg_{f}/cm².

The polymerization is accomplished by continuously supplying ethylene and high α-olefin comonomer having at least 4 carbon atoms in a constant ratio into a continuous slurry polymerization reactor or a loop slurry reactor, a gas phase reactor, or a solution polymerization reactor and copolymerizing according to a general preparation method.

Examples of the high α-olefin comonomer having at least 4 carbon atoms include 1-butene, 1-pentene, 1-hexene, 4-methyl-1-pentene, 1-octene, 1-decene, 1-dodecene, 1-tetradecene, 1-hexadecene, 1-octadecene, 1-eicosen, etc. Among these olefins, α-olefin having 4-10 carbon atoms is preferable. These olefins may be used alone or in combination.

The supported hybrid metallocene catalyst of the present invention can be directly used for olefin polymerization without pretreatment. Also, it can be prepared into a pre-polymerized catalyst by contacting the supported hybrid metallocene catalyst with an olefinic monomer such as ethylene, propylene, 1-butene, 1-hexene, and 1-octene.

The supported hybrid metallocene catalyst of the present invention can be used in an olefin polymerization process after being diluted using an appropriate C₅₋₁₂ aliphatic hydrocarbon solvent, such as isobutane, pentane, hexane, heptane, nonane, decane, or an isomer thereof; an aromatic hydrocarbon solvent, such as toluene or benzene; or a chlorine-substituted hydrocarbon solvent, such as dichloromethane or chlorobenzene. The solvent may be treated with a trace of aluminium to remove catalytic poisons such as water, air, and the like.

The ethylene-based copolymer prepared as described above has an ethylene content of 50-99 wt % and a content of high α-olefin having at least 4 carbon atoms of 1-50 wt %, preferably an ethylene content of 65-98 wt % and a content of high α-olefin having at least 4 carbon atoms of 2-35 wt %, more preferably an ethylene content of 70-96 wt % and a content of high α-olefin having at least 4 carbon atoms of 4-30 wt %. When the ethylene content is greater than 99 wt %, it is difficult to prepare the ethylene-based copolymer. When the ethylene content is less than 50 wt %, it is difficult to expect superior physical properties of the ethylene-based copolymer.

The ethylene-based copolymer prepared using the supported hybrid metallocene catalyst exhibits a bimodal molecular weight distribution of low molecular weight and high molecular weight or multimodal molecular weight distribution and has a polydispersity index, which is a ratio of weight average molecular weight to number average molecular weight, of 5-30. The peak of a molecular weight distribution of a low molecular weight ethylene-based copolymer may be in the range of 1,000 to 100,000 and the peak of a molecular weight distribution of a high molecular weight ethylene-based copolymer may be in the range of 10,000 to 1,000,000. When the peak of molecular weight distribution of low molecular weight ethylene-based copolymer is less than 1,000, processing is difficult due to too low viscosity. When the peak of molecular weight distribution of low molecular weight ethylene-based copolymer is greater than 100,000, processability is poor due to too high viscosity. When the peak of molecular weight distribution of high molecular weight ethylene-based copolymer is less than 10,000, the strength of the ethylene-based copolymer is too low. When the peak of molecular weight distribution of high molecular weight ethylene-based copolymer is greater than 1,000,000, processability is poor due to too high viscosity.

In the bimodal or multimodal molecular weight distribution, the low molecular weight ethylene-based copolymer provides superior processability and the high molecular weight ethylene-based copolymer provides superior internal pressure creep resistance, durability and environmental stress cracking resistance (ESCR).

A melt index of the ethylene-based copolymer is preferably 0.1-1.0 g/10 min, more preferably 0.2-0.7 g/10 min at 190° C. and under a load of 2.16 kg. When the melt index is less than 0.1 g/10 min, the product molding is difficult due to poor fluidity. When the melt index is greater than 1.0 g/10 min, the product molding is difficult due to drop in the molding process.

A density of the ethylene-based copolymer is influenced by an amount of the high α-olefin comonomer used. That is, as the amount of the high α-olefin comonomer used increases, the density of the ethylene-based copolymer decreases. As the amount of the high α-olefin comonomer used decreases, the density of the ethylene-based copolymer increases. The density of the ethylene-based copolymer is 0.920-0.950 g/cm³, in particular 0.925-0.940 g/cm³ in order to obtain optimum internal pressure creep resistance and ESCR of products.

In the preparation of the ethylene-based copolymer, an antioxidant, an UV stabilizer, a pigment for adjusting the color, etc. can be used according to its final use when the ethylene-based copolymer is pelletized. A hindered phenol-based antioxidant may be used in order to prevent a thermal oxidation when passing through an extruder and improve a long-term resistance to thermal oxidation, a hindered amine light stabilizer (HALS) may be used as the UV stabilizer, and a typical color master batch may be used as the pigment for adjusting color. If necessary, a fluorine-based process-aid can be used to improve the appearance of pipes.

The ethylene-based copolymer can be used to prepare a molded pipe such as a pipe for heating and water supply. Preparing the molded pipe can be accomplished by methods typically used in the art, and thus detailed description thereof will be omitted here.

The ethylene-based copolymer is prepared by copolymerizing ethylene monomers and high α-olefin comonomer having at least 4 carbon atoms using the supported hybrid metallocene catalyst in which one metallocene catalyst suitable for the preparation of low molecular weight copolymers and the other metallocene catalyst suitable for the preparation of high molecular weight copolymers are supported on a single support, and thus has a bimodal or multimodal molecular weight distribution. Also, the ethylene-based copolymer of the present invention has a copolymerization distribution with high α-olefin comonomer having at least 4 carbon atoms which is localized in the high molecular weight chain side.

The ethylene-based copolymer of the present invention has superior processability to conventional non-crosslinked polyethylene resins due to the bimodal or multimodal molecular weight distribution and has excellent internal pressure creep resistance due to a copolymerization distribution with high α-olefin comonomer localized in the high molecular weight chain side. Further, since chemical crosslinking is not necessary, a high quality ethylene-based copolymer which has superior producibility and sanitation to conventional chemical crosslinked polyethylene can be obtained.

The present invention will now be described in greater detail with reference to the following examples. The following examples are for illustrative purposes only and are not intended to limit the scope of the invention. In the examples and comparative examples, physical properties were evaluated using the following methods. For a sample containing a crosslinker, the measurements were conducted prior to the addition of the crosslinker.

NMR

A 300 MHz NMR (Bruker) spectrum was obtained to identify the catalyst structure.

Density

The density was determined according to ASTM D792. An apparent density was determined with Apparent Density Tester 1132 according to DIN 53466 and ISO R 60.

Melt Index

The melt index was determined at 190° C. according to ASTM D-1238 under a load of 2.16 kg.

Molecular Weight Distribution

A number average molecular weight, a weight average molecular weight, and a Z average molecular weight were determined by a gel permeation chromatography (GPC). A polydispersity index was determined by dividing the weight average molecular weight by the number average molecular weight.

Tensile Strength, Extension

According to ASTM D638, it was measured using a 2 mm thick hot press sheet

at a stretch rate of 50 mm/min.

Environmental Stress Cracking Resistance (ESCR)

According to ASTM D1693, the ESCR was determined by recording the time until F50 (50% fracture) using a 10% Igepal CO-630 solution at 50° C.

Izod Impact Strength

According to ASTM D256, it was measured at room temperature and at −20° C.

Processability of Pipes

The processability was classified as “good”, “fair” or “poor” on the basis of a line speed (m/min) upon pipe molding.

Internal Pressure Creep Resistance at 95° C.

A test stress of 3.6 MPa was applied to the molded pipes in hot water at 95° C. and the breakdown time was recorded.

Appearance of Pipes

The appearance of pipes was observed with the naked eye and classified as “good”, “fair” or “poor”.

Odor

The molded pipe was cut into 10 pieces so as to have a length of 20 cm, and immersed in 5 L of hot water at 50° C. for 24 hours. Then, an odor of the water was classified as “good”, “fair” or “poor”.

Ease of Installation of Pipes

The ease of installation of the pipes was classified as “good”, “fair” or “poor” on the basis of the possibility of thermal bonding and flexibility when installating the pipes.

Cost Effectiveness

The cost effectiveness was classified as “good” or “bad” on the basis of the costs of raw materials and process and manufacturing costs of the pipes.

Organic reagents and solvents required for the preparation of a catalyst and polymerization were obtained from Aldrich and purified by the standard methods. Ethylene was obtained from Applied Gas Technology as a high purity product and filtered to remove moisture and oxygen before polymerization. Catalyst synthesis, supporting and polymerization were carried out isolated from air and moisture to ensure reproducibility.

### PREPARATION EXAMPLE 1

### Preparation of a first metallocene catalyst—Synthesis of [^{t}Bu-O—(CH₂)₆—C₅H₄]₂ZrCl₂

t-Butyl-O—(CH₂)₆—Cl was prepared using 6-chlorohexanol according to a method reported in literature (Tetrahedron Lett. 2951 (1988)). 8.12 g of t-butyl-O—(CH₂)₆—Cl was reacted with 2N NaCp in 100 mL of anhydrous THF in an ice bath. After 3 hours, 200 mL of water was added. The resulting product was extracted with 100 mL of hexane. Column chromatography was carried out on silica gel using hexane and diethyl ether (v/v=1:1) to obtain 4.07 g of 6-(hydroxy)hexylcyclopentadiene (yield: 82%).

17.9 mmol of 6-(hydroxy)hexylcyclopentadiene was dissolved in 25 mL of THF and 2.7 mL of t-butyl-O—(CH₂)₆—Cl and 3.00 mL of triethylamine were sequentially added thereto. All volatile materials were removed at vacuum and filtered by adding hexane. The filtered solution was vacuum distilled to remove hexane, thereby obtaining 3.37 g of cyclopentadiene having a protected hydroxyl group (tert-butoxy), which was one of the first metallocene catalysts (yield: 79%).

11.4 mmol of cyclopentadiene was dissolved in 20 mL of THF, and then 1.22 g of solid lithium diisopropylamide was added thereto without contacting with air. The reactor was slowly warmed to room temperature and stirring was carried out for 2 hours. All volatile materials were removed with a vacuum pump and 20 mL of THF was added. After adding 2.15 g of ZrCl₄ (THF)₂, the mixture was stirred for 40 hours at 60° C. All volatile materials were removed with a vacuum pump and extraction was carried out using a mixed solvent of toluene and hexane. Thereafter, the resultant was left at room temperature for 1 hour, and then placed in a refrigerator to obtain white solids (yield: 70%)

¹H NMR (300 MHz, CDCl₃): 6.28 (t, J=2.6 Hz, 2H), 6.19 (t, J=2.6 Hz, 2H), 3.31 (t, 6.6 Hz, 2H), 2.62 (t, J=8 Hz), 1.7-1.3 (m, 8H), 1.17 (s, 9H); ¹³C NMR (CDCl₃): 135.09, 116.66, 112.28, 72.42, 61.52, 30.66, 30.61, 30.14, 29.18, 27.58, 26.00.

### PREPARATION EXAMPLE 2

### Preparation of a Second Metallocene Catalyst—Synthesis of [tBu-O—(CH₂)₆](CH₃)Si(C₅H₄)(9-C₁₃H₉)]ZrCl2

A ^{t}Bu-O—(CH₂)₆Cl compound and Mg(O) were reacted in a diethyl ether (Et₂O) solvent to obtain 0.14 mol of a ^{t}Bu-O—(CH₂)₆ MgCl solution, which is a Grignard reagent. Then, a MeSiCl₃ compound (24.7 mL, 0.21 mol) was added at −100° C. Stirring was carried out for over 3 hours at room temperature. Then, the solution was filtered and dried at vacuum to obtain a ^{t}Bu-O—(CH₂)₆SiMeCl₂ compound (yield: 84%).

A fluorenyllithium (4.82 g, 0.028 mol)/hexane (150 mL) solution was slowly added for 2 hours to a ^{t}Bu-O—(CH₂)₆SiMeCl₂ (7.7 g, 0.028 mol) solution dissolved in hexane (50 mL) at −78° C. A white precipitate (LiCl) was filtered out, and extraction was carried out using hexane. All volatile materials were removed by vacuum drying to obtain a pale yellow oily (^{t}Bu-O—(CH₂)₆)SiMe(9-C₁₃H₁₀) compound (yield: 99%).

A THF solvent (50 mL) was added, and a reaction with a C₅H₅Li (2.0 g, 0.028 mol)/THF (50 mL) solution was carried out at room temperature for over 3 hours. All volatile materials were removed by vacuum drying and extraction was carried out using hexane to obtain an orange oily [^{t}Bu-O—(CH₂)₆](CH₃)Si(C₅H₅)(9-C₁₃H₁₀) compound, which is the target ligand (yield: 95%). The structure of the ligand was identified by ¹H NMR.

¹H NMR(400 MHz, CDCl₃): 1.17, 1.15(t-BuO, 9H, s), −0.15, −0.36(MeSi, 3H, s), 0.35, 0.27(CH₂, 2H, m), 0.60, 0.70(CH₂, 2H, m), 1.40, 1.26(CH₂, 4H, m), 1.16, 1.12(CH₂, 2H, m), 3.26(tBuOCH₂, 2H, t, 3JH-H=7 Hz), 2.68(methyleneCpH, 2H, brs), 6.60, 6.52, 6.10(CpH, 3H, brs), 4.10, 4.00(FluH, 1H, s), 7.86(FluH, 2H, m), 7.78(FluH, 1H, m), 7.53(FluH, 1H, m), 7.43-7.22(FluH, 4H, m)

2 equivalents of n-BuLi were added to a (^{t}Bu-O—(CH₂)₆)(CH₃)Si(C₅H₅)(9-C₁₃H₁₀) (12 g, 0.028 mol)/THF (100 mL) solution at −78° C. Heating to room temperature, a reaction was carried out for over 4 hours to obtain an orange solid (^{t}Bu-O—(CH₂)₆)(CH₃)Si(C₅H₅Li)(9-C₁₃H₁₀Li) compound (yield: 81%).

A dilithium salt (2.0 g, 4.5 mmol)/ether (30 mL) solution was slowly added to a ZrCl₄ (1.05 g, 4.50 mmol)/ether (30 mL) suspension at −78° C. A reaction was carried out for 3 hours at room temperature. All volatile materials were removed by vacuum drying, and the resultant oily liquid was filtered by adding a dichloromethane solvent. The filtered solution was vacuum dried, and hexane was added to induce precipitation. The resultant precipitate was washed several times with hexane to obtain a red solid racemic-(^{t}Bu-O—(CH₂)₆(CH₃)Si(C₅H₄)(9-C₁₃H₉)ZrCl₂ compound (yield: 54%).

¹H NMR (400 MHz, CDCl₃): 1.19(t-BuO, 9H, s), 1.13(MeSi, 3H, s), 1.79(CH₂, 4H, m), 1.60(CH₂, 4H, m), 1.48(CH₂, 2H, m), 3.35(tBuOCH₂, 2H, t, 3JH-H=7 Hz), 6.61(CpH, 2H, t, 3JH-H=3 Hz), 5.76(CpH, 2H, d, 3JH-H=3 Hz), 8.13(FluH, 1H, m), 7.83(FluH, 1H, m), 7.78(FluH, 1H, m), 7.65(FluH, 1H, m), 7.54(FluH, 1H, m), 7.30(FluH, 2H, m), 7.06(FluH, 1H, m)

¹³C NMR (400 MHz, CDCl₃): 27.5(Me₃CO, q, 1JC-H=124 Hz), −3.3(MeSi, q, 1JC-H=L121 Hz), 64.6, 66.7, 72.4, 103.3, 127.6, 128.4, 129.0 (7C, s), 61.4(Me₃COCH₂, t, 1JC-H=135 Hz), 14.5(ipsoSiCH₂, t, 1JC-H=122 Hz), 33.1, 30.4, 25.9, 22.7(4C, t, 1JC-H=119 Hz), 110.7, 111.4, 125.0, 125.1, 128.8, 128.1, 126.5, 125.9, 125.3, 125.1, 125.0, 123.8 (FluC and CpC, 12C, d, 1JC-H=171 Hz, 3JC-H=110 Hz)

### PREPARATION EXAMPLE 3

### Preparation of a Second Metallocene Catalyst—Synthesis of (tBu-O—(CH₂)₆)(CH₃)Si(C₅(CH₃)₄)(NCMe₃)TiCl₂

Grignard reagent, a t-butoxyhexylmagnesium chloride solution (0.14 mol) was obtained by reacting t-butoxyhexylchloride with Mg(O) in the presence of diethyl ether (Et₂O) as a solvent. Trichloromethylsilane (24.7 ml, 0.21 mol) was added to the Grignard reagent at −100° C. and the mixture was stirred at room temperature for at least 3 hours and then filtered. The filtrate was dried in a vacuum to obtain t-butoxyhexyldichloromethylsilane (yield 84%).

Meanwhile, n-butyl lithium (26 ml, 0.042 mol) was slowly added to a solution of 1,2,3,4-tetramethylcyclopentadiene (5 g, 0.041 mol) in 100 ml of THF at −78° C. and the mixture was stirred for 2 hours. Then, the solvent was removed and the resultant product was washed with hexane and dried to obtain tetramethylcyclopentadienyl lithium (yield 76%).

A solution of the obtained tetramethylcyclopentadienyl lithium (4.0 g, 0.031 mol) in 100 ml of THF was slowly added to a solution of t-butoxyhexyldichloro-methylsilane (0.12 mol) in 100 ml of THF at −78° C. and the mixture was stirred for 1 hour. Then, the reaction solvent was removed in reduced pressure and the remaining t-butoxyhexyldichloromethylsilane was removed. Then, extraction was carried out with 150 ml of hexane and the solvent was removed. Thus, ^{t}Bu-O—(CH₂)₆SiClMeC₅(CH₃)₄ was obtained as a yellow liquid.

A solution of t-BuNHLi (2.5 g, 0.031 mol) in 50 ml of THF was slowly added to a solution of the obtained tBu-O—(CH₂)₆SiClMe(C₅(CH₃)₄) (6.67 g, 0.031 mol) in 50 ml of THF at −78° C. and the mixture was stirred for 1 hour at room temperature. Then, the solvent was removed and the resultant product was extracted with 150 ml of hexane to obtain ^{t}Bu-O—(CH₂)₆Si(NHt-Bu)Me(C₅(CH₃)₄) as a yellow compound.

A solution of n-butyl lithium (39 ml, 0.062 mol) in hexane was slowly added to a solution of the obtained ^{t}Bu-O—(CH₂)₆Si(NHt-Bu)Me(C₅(CH₃)₄) (0.31 mol) in 100 ml of hexane at −78° C. and the mixture was stirred at room temperature for 24 hours. Then, the solvent was removed and the resultant product was dissolved in 100 ml of toluene. The obtained solution was slowly added to a solution of titanium (III) chloride tetrahydrofuran complex (14.1 g, 0.038 mol) in 100 ml of toluene at −78° C. and the mixture was stirred at room temperature for 12 hours. Subsequently, PbCl₂ (9.0 g, 0.032 mol) was added to the mixture and after stirring for 1.5 hours, the solvent was removed. The desired product was extracted with 100 ml of hexane and the hexane was removed by drying in a vacuum. Thus, ^{t}Bu-O—(CH₂)₆)(CH₃)Si(C₅(CH₃)₄)(NCMe₃)TiCl₂ was obtained as a dark green, sticky substance (yield 54%).

¹H NMR (400 MHz, CDCl₃): 0.67(Si—CH₃, 3H, s), 1.16(t-BuO, 9H, s), 1.45(N C(CH₃)₃, 9H, s), 1.14-1.55 (CH₂, 8H, m), 2.05-2.18 (CH₂, 2H, m), 2.13 (C(CH₃)₂, 6H, s), 2.24(C(CH₃)₂, 6H, s), 3.35 (OCH₂, 2H, t)

### PREPARATION EXAMPLE 4

### Praparation of a Supported Hybrid Metallocene Catalyst

Silica (XPO 2412, Grace Davison) was dehydrated for 15 hours at 800° C. in vacuum. 1.0 g of the silica was placed in 3 glass reactors. After adding 10 mL of hexane, 10 mL of a hexane solution dissolving the first metallocene compound prepared in Preparation Example 1 was added. Then, a reaction was carried out for 4 hours at 90° C. while stirring the reactor. After the reaction was completed, the hexane was removed by separation. After washing three times with 20 mL of a hexane solution, the hexane was removed by suction to obtain a solid powder. A methylaluminoxane (MAO) solution containing 12 mmol of aluminium in a toluene solvent was added at 40° C. while stirring. The unreacted aluminium compound was removed by washing a sufficient amount of toluene. Then, the remaining toluene was removed by suction at 50° C.

To prepare a supported hybrid metallocene catalyst, a toluene solution, dissolving the second metallocene compound prepared in Preparation Example 2, was added in a glass reactor. A reaction was carried out at 40° C. while stirring the reactor. After washing with a sufficient amount of toluene, drying was carried out to obtain a solid powder. The resultant supported hybrid catalyst can be used as a catalyst without further treatment. Alternatively, 30 psig of ethylene may be added for 2 minutes and a prepolymerization can be carried out for 1 hour at room temperature. The powder was vacuum dried to obtain a solid supported hybrid metallocene catalyst.

### EXAMPLE 1

The supported hybrid metallocene catalyst prepared in Preparation Example 4 was subjected to a continuous slurry polymerization process. Ethylene-based copolymers were prepared by feeding ethylene monomer at a rate of 12 kg/hr and comonomer at a rate of 50 g/hr at 9 atm and 80° C. 1-Butene was used as the comonomer. Each 2,000 ppm of an antioxidant (Iganox 1010, Igafos 168, CIBA) and an UV stabilizer (Chimassorb944, CIBA) was added and pellets were produced using W&P twin screw extruder (44 φ, L/D=30) at an extrusion temperature of 210° C. A pipe was molded using a single-screw extruder (Battenfeld Pipe M/C, 50 φ, L/D=22, compression ratio=3.5) at an extrusion temperature of 220° C. so as to have an outer diameter of 32 mm and a thickness of 2.9 mm. Physical properties and pipe processability of the ethylene-based copolymer and physical properties of the pipe were evaluated according to methods described above and the results are set forth in Table 1.

### EXAMPLE 2

1 kg of the supported hybrid metallocene catalyst of Preparation Example 4 was suspended in 50 L of a purified isobutane solution, and transferred to a continuous stirring tank reactor. The catalyst injection amount was controlled to 5 g/min. The polymerization was carried out according to a continuous slurry loop polymerization process in which the polymerization temperature was controllable. The polymerization time was controlled such that the residence time in the reactor is 2 hours and the solvent amount was also correspondingly controlled. The polymer slurry removed from the reactor was passed through a centrifuge and a drier to obtain a powder. Ethylene was fed at a rate of 5-20 kg/hr. The catalyst injection amount was controlled such that the ethylene pressure remains at 5-50 kg_{f}/cm² at 80-120′. Each 10 mL of the catalyst was injected at time intervals. 1-Hexene was used as a comonomer to control the copolymerization characteristics and density. A small amount of hydrogen was added to control the molecular weight. Physical properties and pipe processability of the ethylene-based copolymer and physical properties of the pipe were evaluated according to methods described above and the results are set forth in Table 1.

### EXAMPLE 3

An ethylene-based copolymer was prepared using the supported hybrid metallocene catalyst prepared in Preparation Example 4 and a gas phase polymerization process. 1-Hexene was used as a comonomer. Physical properties and pipe processability of the ethylene-based copolymer and physical properties of the pipe were evaluated according to methods described above and the results are set forth in Table 1.

### EXAMPLE 4

An ethylene-based copolymer was prepared using the supported hybrid metallocene catalyst prepared in Preparation Example 4 and a solution polymerization process. 1-Octene was used as a comonomer. Physical properties and pipe processability of the ethylene-based copolymer and physical properties of the pipe were evaluated according to methods described above and the results are set forth in Table 1.

### COMPARATIVE EXAMPLE 1

An ethylene-based copolymer was prepared using an Mg supported Ti type Ziegler-Natta catalyst (THE catalyst, Hoechst, Germany), which is a slurry polymerization catalyst used in the preparation of general-purpose polyethylene pipes, 1-butene as a comonomer, and a continuous slurry polymerization process. 0.7 wt. % of an organic peroxide and 0.3 wt. % of an antioxidant were added to the ethylene-based copolymer. The mixture was molded into a chemically crosslinked pipe with the same dimension as in the above Examples. The results of evaluating the characteristics are shown in Table 2.

### COMPARATIVE EXAMPLE 2

An ethylene copolymer was prepared using an Mg supported Ti type Ziegler Natta catalyst, 1-butene as a comonomer, and a gas phase polymerization process. 2.0 wt. % of a silane compound, 0.3 wt. % of an organic peroxide, and 0.2 wt. % of an antioxidant were added to the ethylene copolymer. The mixture was molded into a moisture-crosslinked pipe with the same dimensions as in the above Examples. The results of evaluating of the characteristics are displayed in Table 2.

### COMPARATIVE EXAMPLE 3

An ethylene copolymer was prepared using an silica supported Cr type Ziegler Natta catalyst, 1-hexene as a comonomer, and a slurry loop polymerization process. The ethylene-based copolymer was molded into a pipe with the same dimensions as in the above Examples. The results of evaluating of the characteristics are displayed in Table 2.

### COMPARATIVE EXAMPLE 4

An ethylene copolymer was prepared using a Ziegler-Natta catalyst, 1-octene as a comonomer, and a solution polymerization process. The ethylene-based copolymer was molded into a pipe with the same dimensions as in the above Examples. The results of evaluating of the characteristics are displayed in Table 2.

### COMPARATIVE EXAMPLE 5

An ethylene copolymer was prepared using the first metallocene catalyst prepared in Preparation Example 1, 1-butene as a comonomer, and a continuous slurry polymerization process. The ethylene-based copolymer had a unimodal molecular weight distribution and a pipe with the same dimensions as in the above Examples was molded. The results of evaluating of the characteristics are displayed in Table 2.

TABLE 1

| Classification | Example 1 | Example 2 | Example 3 | Example 4 |
|---|---|---|---|---|
| Catalyst | M1 | M1 | M1 | M1 |
| Polymerization | Hexane slurry | Isobutane slurry | Fluidized bed gas | Solution process |
| Process | (continuous stirred | (loop reactor) | phase reactor | (Hexane solvent) |
| | tank reactor) | | | |
| Comonomer | 1-Butene | 1-Hexene | 1-Hexene | 1-Octene |
| Crosslinking | Non-crosslinking | Non-crosslinking | Non-crosslinking | Non-crosslinking |

Physical properties of ethylene-based copolymer

| | | | | |
|---|---|---|---|---|
| Density (g/cm³) | 0.933 | 0.935 | 0.934 | 0.932 |
| Melt Index | 0.5 | 0.3 | 0.6 | 0.7 |
| Molecular weight | Bimodal | Bimodal | Bimodal | Bimodal |
| distribution | | | | |
| Polydispersity | 17.3 | 15.2 | 18.7 | 13.1 |
| index | | | | |
| Tensile strength | 280 | 275 | 270 | 265 |
| (kg/cm²) | | | | |
| Extension (%) | 890 | 850 | 870 | 900 |
| ESCR, F50 | >1,000 | >1,000 | >1,000 | >1,000 |
| Izod impact | NB | NB | NB | NB |
| strength | | | | |
| Room | 25 | 24 | 26 | 28 |
| temperature −20° C. | | | | |

Processability of pipe

| | | | | |
|---|---|---|---|---|
| Processability | Good | Good | Good | Good |
| (line speed: | 19 | 20 | 18 | 20 |
| m/min) | | | | |

Physical properties of pipe

| | | | | |
|---|---|---|---|---|
| Internal pressure | >1200 | >1200 | >1200 | >1200 |
| creep resistance | | | | |
| at 95° C. | | | | |
| Appearance | Good | Good | Good | Good |
| Odor | Good | Good | Good | Good |
| Ease of | Good | Good | Good | Good |
| Installation | | | | |
| Cost effectiveness | Good | Good | Good | Good |

TABLE 2

| | Comparative | Comparative | Comparative | Comparative | Comparative |
|---|---|---|---|---|---|
| Classification | Example 1 | Example 2 | Example 3 | Example 4 | Example 5 |
| Catalyst | Z-N | Z-N | Z-N | Z-N | M2 |
| Polymerization | Hexane slurry | Fluidized bed | Isobutane slurry | Solution process | Hexane slurry |
| Process | (continuous | gas phase | (loop reactor) | (Hexane solvent) | (continuous |
| | stirred tank | reactor | | | stirred tank |
| | reactor) | | | | reactor) |
| Comonomer | 1-Butene | 1-Butene | 1-Hexene | 1-Octene | 1-Butene |
| Crosslinking | chemical- | Moisture- | Non-crosslinking | Non-crosslinking | Non-crosslinking |
| | crosslinking | crosslinking | | | |

Physical properties of ethylene-based copolymer

| | | | | | |
|---|---|---|---|---|---|
| Density (g/cm³) | 0.949 | 0.948 | 0.939 | 0.933 | 0.940 |
| Melt Index | 0.01 | 5.5 | 0.2 | 0.7 | 0.9 |
| Molecular weight | Unimodal | Unimodal | Bimodal | Unimodal | Unimodal |
| distribution | | | | | |
| Polydispersity | 4.6 | 4.2 | 20.5 | 4.7 | 2.9 |
| index | | | | | |
| Tensile strength | 301 | 293 | 292 | 264 | 252 |
| (kg/cm²) | | | | | |
| Extension (%) | 20 | 45 | 920 | 870 | 840 |
| ESCR, F50 | >1,000 | >1,000 | >1,000 | >1,000 | 580 |
| Izod impact | NB | NB | NB | NB | NB |
| strength | | | | | |
| Room | 22 | 18 | 15 | 27 | 4 |
| temperature −20° C. | | | | | |

Processability of pipe

| | | | | | |
|---|---|---|---|---|---|
| Processability | Poor | Fair | Fair | Fair | Poor |
| (line speed: | 1.7 | 14 | 7 | 12 | (impossible) |
| m/min) | | | | | |

Physical properties of pipe

| | | | | | |
|---|---|---|---|---|---|
| Internal pressure | >1200 | >1200 | >1200 | >1200 | — |
| creep resistance | | | | | |
| at 95° C. | | | | | |
| Appearance | Good | Good | Good | Fair | — |
| Odor | Fair | Poor | Good | Good | — |
| Ease of | Poor | Poor | Poor | Good | — |
| Installation | | | | | |
| Cost | Bad | Bad | Good | Bad | — |
| effectiveness | | | | | |

NB = No break;
M1 = Supported hybrid metallocene catalyst;
Z-N = Ziegler-Natta catalyst;
M2 = The first metallocene catalyst containing one active component

As apparent from Tables 1 and 2, when the ethylene-based copolymers obtained in Examples 1-4 are applied to water supply pipes or heatpipes, since crosslinking is not performed, the pipes are more suitable for drinking water than the chemically-crosslinked pipes obtained in Comparative Examples 1 and 2 due to cost effectiveness and no odor, and can be thermally bonded, thus easily being installed. The product of Comparative Example 3 has a high polydispersity similar to the products of Examples 1-4, but has a limitation in the amount of comonomer added due to the Ziegler-Natta catalyst, and thus has low productivity due to low melt index. The product of Comparative Example 4 using 1-octene as a comonomer has sufficient physical properties, but has poor processability due to a narrow molecular weight distribution and rough appearance. The product of Comparative Example 5 uses a metallocene catalyst as in Examples, but has poor processability due to a typical narrow molecular weight distribution.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A supported hybrid metallocene catalyst comprising a first metallocene catalyst represented by formula (1), a second metallocene catalyst represented by formula (2) or (3), a cocatalyst, and a support:
(C₅R¹)ₚ(C₅R¹)MQ₃₋ₚ (1)
in which M is a Group IV transition metal;
(C₅R¹) is a cyclopentadienyl or a cyclopentadienyl ligand substituted by a metalloid radical of a Group XIV metal substituted by a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkylaryl group, a C₇₋₄₀ arylalkyl group, a C₈₋₄₀ arylalkenyl group, a C₂₋₁₀ alkynyl group, or a hydrocarbyl; or a cyclopentadienyl or a substituted cyclopentadienyl ligand wherein two neighboring carbon atoms of C₅ are connected by a hydrocarbyl radical to form at least one C₄ to C₈ ring;
Q is a halogen atom, a C₁₋₂₀ alkyl group, a C₂₋₁₀ alkenyl group, a C₇₋₄₀ alkylaryl group, a C₇₋₄₀ arylalkyl group, a C₆₋₂₀ aryl group, a substituted or unsubstituted C₁₋₂₀ alkylidene, a substituted or unsubstituted amino group, a C₂₋₂₀ alkylalkoxy group, or a C₇₋₄₀ arylalkoxy group; and
p is 0 or 1; 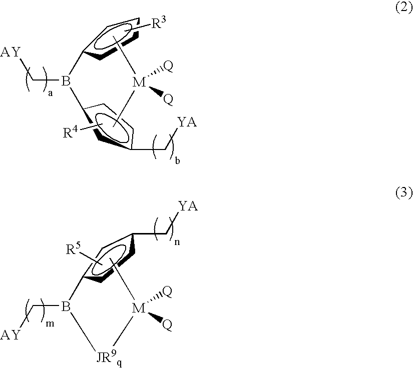
in which M is a Group IV transition metal;
each of (C₅R³), (C₅R⁴) and (C₅R⁵) is a cyclopentadienyl or a cyclopentadienyl ligand substituted by a metalloid radical of a Group XIV metal substituted by a C₁₋₄₀ alkyl group, a C₄₋₄₀ cycloalkyl group, a C₁₋₂₀ alkoxy group, a C₆₋₄₀ aryl group, a C₆₋₂₀ aryloxy group, a C₂₋₄₀ alkenyl group, a C₇₋₄₀ alkylaryl group, a C₇₋₄₀ arylalkyl group, a C₈₋₄₀ arylalkenyl group, a C₂₋₂₀ alkynyl group, or a hydrocarbyl; or a cyclopentadienyl or a substituted cyclopentadienyl ligand wherein two neighboring carbon atoms of C₅ are connected by a hydrocarbyl radical to form at least one C₄ to C₁₆ ring;
A is a hydrogen atom, a C₁₋₂₀ alkyl group, a C₂₋₂₀ alkenyl group, a C₆₋₂₀ aryl group, a C₇₋₄₀ alkylaryl group, a C₇₋₄₀ arylalkyl group, a C₁₋₂₀ alkylsilyl group, a C₆₋₂₀ arylsilyl group, methoxymethyl, t-butoxymethyl, tetrahydropyranyl, tetrahydrofuranyl, 1-ethoxyethyl, 1-methyl-1-methoxyethyl, or t-butyl;
Y is an oxygen or nitrogen atom;
Q is a halogen atom, a C₁₋₂₀ alkyl group, a C₂₋₁₀ alkenyl group, a C₇₋₄₀ alkylaryl group, a C₇₋₄₀ arylalkyl group, a C₆₋₂₀ aryl group, a substituted or unsubstituted C₁₋₂₀ alkylidene, a substituted or unsubstituted amino group, a C₂₋₂₀ alkylalkoxy group, or a C₇₋₄₀ arylalkoxy group;
B is a bridge that binds two cyclopentadienyl ligands or binds a cyclopentadienyl ligand and JR⁹_{q} by a covalent bond, the bridge comprising a C₁₋₄ alkylene radical, C₁₋₄ dialkylsilicon or dialkylgermanium, or C₁₋₄ alkyl phosphine or amine;
R⁹ is a hydrogen atom, a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkylaryl group, a C₇₋₄₀ arylalkyl group, a C₈₋₄₀ arylalkenyl group, or a C₂₋₁₀ alkynyl group;
J is a Group XV element or a Group XVI element;
q is an integer of 0-3; and
a, b, m, and n are identical or different and are an integer of 0-20.

2. The supported hybrid metallocene catalyst of claim 1, wherein a content of M of the metallocene catalyst is 0.1-20 wt %.

3. The supported hybrid metallocene catalyst of claim 1, wherein a mole ratio of the first metallocene catalyst/the second metallocene catalyst is 0.01-100.

4. The supported hybrid metallocene catalyst of claim 1, wherein the cocatalyst is a linear, cyclic, or net-shaped compound represented by formula (4):
−[Al(R⁶)—O]_{c}— (4)
in which R⁶ is identical or different and is a halogen radical, a C₁₋₂₀ hydrocarbyl radical, or a C₁₋₂₀ hydrocarbyl radical substituted by halogen; and
c is an integer of 2 or more.

5. The supported hybrid metallocene catalyst of claim 1, wherein the cocatalyst is a compound represented by formula (5):
N(R⁶)₃ (5)
in which N is aluminium or boron,
R⁶ is as defined in claim 5, and
three R⁶s are identical or different.

6. The supported hybrid metallocene catalyst of claim 1, wherein the cocatalyst is a compound represented by formula (6);
[L-H]⁺[NE₄]⁻ or [L]⁺[NE₄]⁻ (6)
in which L is a neutral or cationic Lewis acid,
H is a hydrogen atom,
N is a Group XIII element,
E is a C₆₋₄₀ aryl radical substituted by at least one among a halogen radical, a C₁₋₂₀ hydrocarbyl radical, an alkoxy radical, a phenoxy radical, and a C₁₋₂₀ hydrocarbyl radical containing a nitrogen, phosphorus, sulfur, or oxygen atom, and four Es are identical or different.

7. The supported hybrid metallocene catalyst of claim 4, wherein a mole ratio of the Group XIII metal/M of the metallocene catalyst is 1-10,000.

8. The supported hybrid metallocene catalyst of claim 1, wherein the support is silica, silica-alumina, or silica-magnesia.

9. A method of preparing a supported hybrid metallocene catalyst, the method comprising:
reacting a supported metallocene catalyst in which one of a first metallocene catalyst represented by formula (1) and a second metallocene catalyst represented by formula (2) or (3) is supported with a cocatalyst to prepare an activated supported metallocene catalyst; and
further supporting the other metallocene catalyst of the metallocene catalyst represented by formula (1) and the metallocene catalyst represented by formula (2) or (3) on the activated supported metallocene catalyst:
(C₅R¹)ₚ(C₅R¹)MQ₃₋ₚ (1)
in which M, (C₅R¹), Q, and p are as defined in claim 1; and 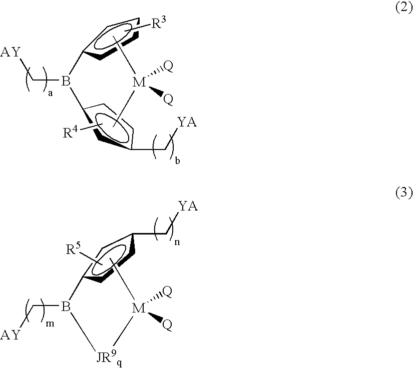
in which M, (C₅R³), (C₅R⁴), (C₅R⁵), A, Y, Q, B, R⁹, J, a, b, m, n, and q are as defined in claim 1.

10. A method of preparing an ethylene-based copolymer, the method comprising:
supplying a supported hybrid metallocene catalyst including a first metallocene catalyst represented by formula (1), a second metallocene catalyst represented by formula (2) or (3), a cocatalyst, and a support; an ethylene monomer; and a high α-olefin comonomer having at least 4 carbon atoms to a polymerization reactor to polymerize at 25-500° C. and 1-100 kg_{f}/cm² for 1-24 hours:
(C₅R¹)ₚ(C₅R¹)MQ₃₋ₚ (1)
in which M, (C₅R¹), Q, and p are as defined in claim 1; and 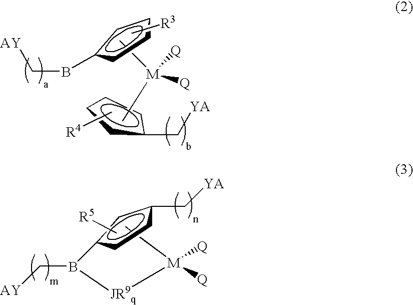
in which M, (C₅R³), (C₅R⁴), (C₅R⁵), A, Y, Q, B, R⁹, J, a, b, m, n, and q are as defined in claim 1.

11. The method of claim 10, wherein the high α-olefin comonomer having at least 4 carbon atoms is 1-butene, 1-pentene, 1-hexene, 4-methyl-1-pentene, 1-octene, 1-decene, 1-dodecene, 1-tetradecene, 1-hexadecene, 1-octadecene, 1-eicosen, or a mixture thereof.

12. The method of claim 10, wherein the supported hybrid metallocene catalyst and the olefin monomer are polymerized previously, and then supplied to the polymerization reactor.

13. The method of claim 10, wherein the supported hybrid metallocene catalyst is mixed with an aliphatic hydrocarbon solvent having 5-12 carbon atoms, which is pretreated with aluminium, and then supplied to the polymerization reactor.

14. An ethylene-based copolymer prepared by the method of claim 10, which has a bimodal or multimodal molecular weight distribution, an ethylene content of 50-99 wt %, and a content of a high α-olefin having at least 4 carbon atoms of 1-50 wt %.

15. The ethylene-based copolymer of claim 14, which has a polydispersity of 5-30.

16. The ethylene-based copolymer of claim 14, which has a melt index of 0.1-1.0 g/10 min (190° C., a load of 2.16 kg).

17. The ethylene-based copolymer of claim 14, which has a density of 0.920-0.950 g/cm³.

18. The ethylene-based copolymer of claim 14, wherein the ethylene-based copolymer has a bimodal molecular weight distribution, and a peak of a molecular weight distribution of a low molecular weight ethylene-based copolymer is in the range of 1,000 to 100,000 and a peak of a molecular weight distribution of a high molecular weight ethylene-based copolymer is in the range of 10,000 to 1,000,000.

19. A molded material for pipes, prepared using the ethylene-based copolymer of claim 14.
